(19) United States
(12) Patent Application Publication
(10) Pub. No.: US 2012/0293731 A1
(43) Pub. Date: Nov. 22, 2012

(54) Displaying Decompressed Pictures on Liquid Crystal Displays in Macroblock Raster Scan Order

(76) Inventors: Mikhail S. Tsvetkov, Mytishchi (RU); Andrey Efimov, Saint-Petersburg (RU); Eugeniy A. Belyaev, Saint-Petersburg (RU)

(21) Appl. No.: 13/511,781

(22) PCT Filed: Nov. 24, 2009
(86) PCT No.: PCT/RU09/00647

§ 371 Date: May 24, 2012

(51) Int. Cl. H04N 3/10

(52) U.S. Cl. 348/792; 348/E03.011

(57) ABSTRACT

A macroblock-scanned picture may be shown directly on a thin film transistor liquid crystal display in macroblock scan order. This enables eliminating conversion operation from macroblock raster scan to line scan order that requires expensive and power-hungry memory for a frame buffer, in some embodiments, which results in a cost savings.

### BACKGROUND

This, relates generally to image systems with compression and, particularly, to the display of pictures on liquid crystal displays.

In conventional liquid crystal display systems, an FPD-link interface is used. One such device is the FPD87352 CXA TFT liquid crystal display timing control device available from National Semiconductor, Sunnyvale, Calif.

The FPD-link interface couples a decoder, such as an H.264 decoder, to the liquid crystal control logic. The liquid crystal control logic, in turn, is coupled to gate driver integrated circuits and source driver integrated circuits that drive a thin film transistor (TFT) display liquid crystal display. As a result, the decoder has to use a frame buffer to convert the macroblock scanned decoded stream to a line scanned flat panel display stream. The frame buffer requires a memory size that is expensive and power hungry. For example, a frame buffer for converting high-definition image between different scan formats may be utilized and, conventionally, the output buffer is about six megabytes of synchronous dynamic random access memory (SDRAM).

### BRIEF DESCRIPTION OF THE DRAWINGS

FIG. 1 is a schematic for one embodiment of the present invention;

FIG. 2 is a more detailed depiction of the LCD control logic according to one embodiment; and

FIG. 3 is a flow chart for one embodiment.

### DETAILED DESCRIPTION

The FPD-link may be eliminated by using a macroblock transfer interface. The decoded macroblock may then be transferred directly to TFT liquid crystal control logic. Then, there is no requirement to convert the decoder output to FPD-link line scan format. This is because the native TFT liquid crystal display has a pixel addressable architecture.

The FPD-link is a low voltage differential signaling (LVDS) bus that is used to transmit data pixel-by-pixel in line scan order with a bundled clock, data enable, vertical, and horizontal synchronization signals. The FPD-link can be replaced by a macroblock interface. In one embodiment, the decoder may be compliant with the H.264 standard. See, ITU-T 14496-10, Advanced Video Coding for Generic AudioVisual Services, International Telecommunications Union, Geneva, Switzerland (01-04-2007).

Macroblock interface signals are a clock, data, data enable, and macroblock address. A macroblock address is the index of a macroblock in a macroblock raster scan of the picture.

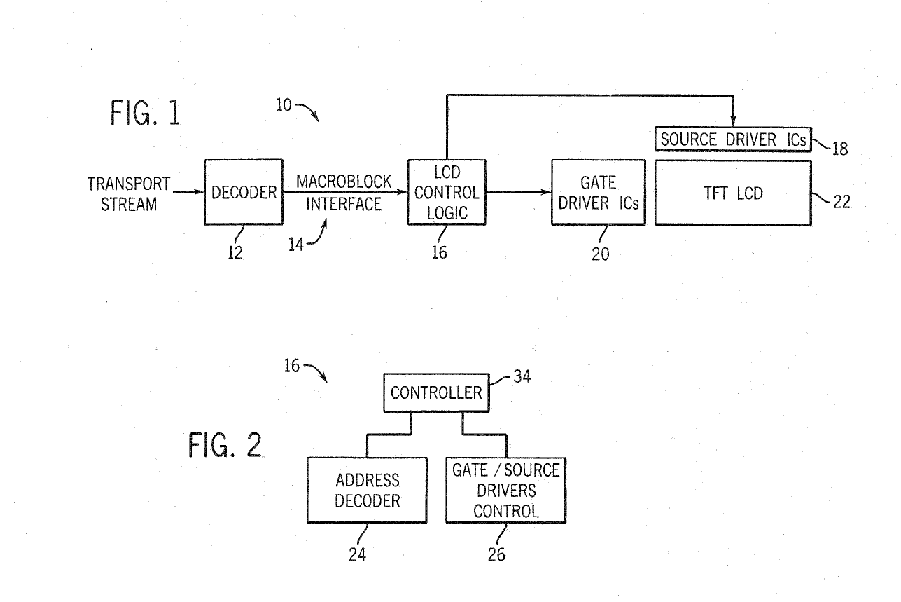

Thus, referring to FIG. 1, in accordance with one embodiment, a transport stream is provided to a decoder 12 in accordance with one embodiment. The decoder outputs to a macroblock interface 14, coupled to a liquid crystal display control logic 16.

The logic 16 is connected to a source driver integrated circuit 18 and a gate driver integrated circuit 20. The circuits 18 and 20 drive the TFT liquid crystal display 22. The liquid crystal display 22 may be a flat panel, active matrix, liquid crystal thin film transistor display of the type commonly used as television displays or computer monitors. Each thin film transistor is in series with a different pixel to form a one module, active matrix liquid crystal display panel in one embodiment. The matrix array may be positioned adjacent red, green, and blue color filters. Each pixel includes a thin film transistor with one electrode acting as the data line electrode. The intensity of the light transmitted by each pixel is determined by a drive voltage applied to the pixel's data electrode when a scan electrode, its other electrode, is pulsed high. Thus, each pixel is driven by a column driver or source driver 18, driving vertical data lines. When a horizontal line or row is selected, all the thin film transistors connected to the line are turned on and data driven by the column or source drivers 18 is loaded into the pixel electrodes via parallel conductors.

The liquid crystal display control logic 16 serves as an interface to the row or gate and column or source driver integrated circuits 20 and 18, respectively. As shown in FIG. 2, the control logic 16 may include a programmable controller integrated circuit 34 to drive various displays with different configuration parameters. It may also include a digital-to-analog converter integrated circuit (not shown) with a color lookup table with digital-to-analog conversion to map a given color space into individual color components used to drive displays.

The controller 34 may be coupled to an address block decoder 24 and a gate/source drivers control 26 that outputs macroblock pixel data into an appropriate region of the display picture. Thus, in one embodiment, the mapping algorithm maps that macroblock pixels into the LCD pixels is executed by the controller 34. It receives decoded block address from decoder 24 and calculates inputs for drivers control 26.

In such an embodiment, no frame buffer is needed and, as a result, the relatively high cost of a synchronous dynamic random access memory frame buffer may be eliminated in some embodiments. Then, the image data is directly transferred from the decoder output in macroblock raster scan order.

A raster scan is a rectangular pattern of image capture and reconstruction used in electronics graphics. An image is subdivided into a sequence of parts called scan blocks, each of which can be transmitted independently. Conventional line scanned order simply goes from the beginning of one line to its end and starts from the end of the next line and goes to the beginning of the next line. In this case, each image line corresponds to one scan block. In a more complex case, such as with a reconstruction encoded picture, a scan block may be any rectangular area mapped in the image. For example, the H.264 decoding algorithm deals with macroblocks of 16×16 pixel size. Therefore, each macroblock, in this case, consists pixels from 16 consecutive lines, 16 pixels from each line. In addition, macroblocks can be restored in a random order.

To map a macroblock within the whole picture, the macroblock address is used. A macroblock address is the index of a macroblock in a macroblock raster scan of the picture starting with zero for the top-left macroblock in a picture.

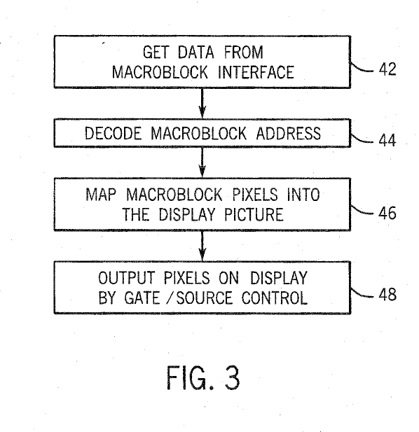

Referring to FIG. 3, a sequence may be implemented in software, hardware, or a combination of the two. In a software implemented embodiment, the sequence may be implemented by instructions executed by a processor or controller such as the controller 34. The sequence of instructions may be stored in a memory internal or external to the controller 34. These instructions may be stored in a variety of memories and executed by any of a variety of controllers in a variety of locations.

In one embodiment, after the transport stream is decoded, the decoded data may be retrieved from a macroblock interface, as indicated in block 42 in FIG. 3. The macroblock interface transmits a video frame per macroblock instead of per line. Then, in block 44, the macroblock addresses are decoded. Next, the macroblock pixels are mapped into the display picture, as indicated in block 46. Finally, the picture is displayed in macroblock scan order, as indicated in block 48, in accordance with some embodiments, by outputting pixels onto a display by the gate/source drivers control 26.

The graphics processing techniques described herein may be implemented in various hardware architectures. For example, graphics functionality may be integrated within a mobile devices chipset. Alternatively, a discrete decoder may be used. As still another embodiment, the graphics functions may be implemented by a general purpose display, including a LCD TV.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
directly showing a picture on a thin film transistor liquid crystal display in macroblock scan order.

2. The method of claim 1 including using a macroblock interface to transmit a video frame per macroblock.

3. The method of claim 1 including processing a transport stream for a thin film transistor liquid crystal display without using a frame buffer.

4. The method of claim 1 including macroblock interface signals in the form of clock, data, data enable, and macroblock address wherein the macroblock address is the index of the macroblock in a macroblock raster scan.

5. The method of claim 1 including coupling a macroblock interface to a liquid crystal display control logic including a gate/source drivers control.

6. The method of claim 5 including providing a macroblock address decoder in said liquid crystal control logic.

7. The method of claim 1 including mapping a scan block to an image.

8. The method of claim 1 including using a macroblock address to map a macroblock within a picture to the picture itself.

9. The method of claim 8 including as said macroblock address an index of a macroblock in a macroblock raster scan starting with zero for the top left macroblock in the picture.

10. A display system comprising:
a thin film transistor liquid crystal display;
a liquid crystal display control logic coupled to said display; and
a decoder coupled to said liquid crystal control logic through a macroblock interface.

11. The system of claim 10 wherein said macroblock interface to transmit a video frame per macroblock.

12. The system of claim 10 wherein said display to display a picture of macroblock scan order.

13. The system of claim 10 without a frame buffer.

14. The system of claim 10 wherein said macroblock interface to use signals including clock, data, data enable, and macroblock address, wherein the macroblock address is the index of the macroblock in a macroblock raster scan.

15. The system of claim 10 wherein said liquid crystal display control logic includes a gate/source drivers control.

16. The system of claim 10 wherein said liquid crystal display control logic includes a macroblock address decoder.

17. The system of claim 10 wherein said liquid crystal display control logic to map a scan block to an image.

18. The system of claim 10 wherein said control logic to use a macroblock address to map a macroblock within a picture to the picture itself.

19. The system of claim 18 wherein said macroblock address is an index of a macroblock in a macroblock raster scan starting with zero for the top left macroblock in the picture.

20. A computer readable medium storing instructions to enable a computer to:
receive decoded data from a macroblock interface; and
directly show a picture on a thin film transistor liquid crystal display in macroblock scan order.

21. The medium of claim 20 further storing instructions to decode a macroblock address.

22. The medium of claim 21 further storing instructions to map macroblock pixels into a display picture.

23. The medium of claim 20 further storing instructions to transmit a video frame per macroblock instead of per line.

24. The medium of claim 20 further storing instructions to enable the processing of the transport stream for a thin film transistor liquid crystal display without using a frame buffer.

25. The medium of claim 20 further storing instructions to process macroblock interface signals in the form of clock, data, data enable, and macroblock address wherein the macroblock address is the index of the macroblock in a macroblock raster scan.
